(19) United States
(12) Patent Application Publication
(10) Pub. No.: US 2013/0271420 A1
(43) Pub. Date: Oct. 17, 2013

(54) TOUCH CONTROL APPARATUS AND TOUCH DETECTION METHOD THEREOF

(71) Applicants: Chun-Hung Chen, Taipei City (TW); He-Wei Huang, Hsinchu City (TW)

(72) Inventors: Chun-Hung Chen, Taipei City (TW); He-Wei Huang, Hsinchu City (TW)

(73) Assignee: Novatek Microelectronics Corp., Hsinchu (TW)

(21) Appl. No.: 13/607,809

(22) Filed: Sep. 10, 2012

(30) Foreign Application Priority Data
Apr. 16, 2012 (TW) 101113478

(51) Int. Cl. G06F 3/044

(52) U.S. Cl. 345/174

(57) ABSTRACT

A touch detection method is used in a touch panel. The touch panel is capacitive touch panel integrated with a display panel. The method includes at least obtaining at least one control signal carrying synchronous information from the display panel. The control signal is used to control the display panel to display an image. The method also includes analyzing the control signal to obtain an interference time period, at which the touch panel is possibly interfered, and generating a trigger signal. A driving voltage signal and a sensing period of the touch panel are controlled according to the trigger signal, so that the sensing period is not overlapped with the interference time period.

### CROSS-REFERENCE TO RELATED APPLICATION

This application claims the priority benefit of Taiwan application serial no. 101113478, filed on Apr. 16, 2012. The entirety of the above-mentioned patent application is hereby incorporated by reference herein and made a part of this specification.

### BACKGROUND OF THE INVENTION

1. Field of the Invention

The invention relates to a touch panel. Particularly, the invention relates to a technique of reducing interference of driving signals of a display panel on a capacitive touch panel.

2. Description of Related Art

A touch panel is capable of receiving an input signal through a touch operation performed by a touch object such as a finger or a stylus.

FIG. 1 is a structural schematic diagram of a conventional touch device. Referring to FIG. 1, the touch device has a touch panel 52, and an image display device 50 under the touch panel 52 provides a screen. The image display device 50 is, for example, a liquid crystal display (LCD) panel, which is used to display images suitable for touching. When a touch object touches the touch panel 52, a touch position is detected, and a corresponding position on the screen is obtained. The touch system can respond according to an image content corresponding to the touch position, and change a display content of the screen to implement a touch operation.

The touch panels are divided into different types according to different operating principle of touch sensors, in which a capacitive touch panel is a commonly used one, and an operating principle thereof is that a surface thereof receives a touch operation from a touch object (which is generally an insulator), and a driving voltage is sequentially input through driving lines 54. When the driving voltage is input to each of the driving lines 54, a scan line 56 scans a voltage thereon. When a voltage variation is generated due to variation of a capacitance between the surface touch object and the touch panel, it is obtained that a touch event is occurred, and a touch position thereof is determined.

FIG. 2A is a circuit schematic diagram of a conventional touch device. Referring to FIG. 2A, a capacitance touch panel 70 has a spatial resolution of m×n, which has m driving lines 54 and n scan lines 56. An LCD panel under the capacitive touch panel 70 is controlled by a gate and source driving circuit 74 and a control circuit of the LCD system to display images. A capacitive sensing circuit 72 drives the capacitive touch panel 70.

When a mutual sensing mechanism is used to detect the touch position, a driving/sensing control unit 78 of the capacitive sensing circuit 72 inputs driving pulses to driving lines y₁-yₘ in time-division, and each time when the driving pulse is input, scan lines x₁-xₘ convert raw data through anlog-to-digital converters (ADCs), and a data storage unit 80 stores voltage signals for providing to subsequent touch judgement processing.

FIG. 2B is a timing diagram of a driving signal and a scan signal. Referring to FIG. 2B, when the driving pulse is input to the driving line, it is required to wait the voltage on the scan line to be stable (shown as a dot marking region in FIG. 2B) before activating the ADC to perform sensing conversion, and conversion of one batch of scan data is completed after a period of time.

Referring to FIG. 1 again, as the capacitive touch panel 52 collocates with the LCD panel 50, when the LCD panel 50 starts to display an image content, control signals related to synchronization on the LCD panel 50, for example, a control signal 58 such as a source control signal, a gate control signal or a common voltage (VCOM) signal, etc. may produce coupling capacitances between the LCD panel 50 and the capacitive touch panel 52, which may interfere the scan lines 56 of the touch panel, so that a sensing output signal 60 carries a noise component of the LCD panel 50. Such noise may cause situations such as misjudgement, jitter or poor linearity in determination of the touch position.

How to reduce the situation that the LCD panel 50 interferes the touch panel 52 is still an important issue required to be further developed.

### SUMMARY OF THE INVENTION

The invention is directed to a technique of reducing interference of driving signals of a display panel on a capacitive touch panel, by which a detection of a touch position is more accurate.

The invention provides a touch detection method for a touch panel. The touch panel is a capacitive touch panel integrated with a display panel. The method is described as follows. At least one control signal carrying synchronous information is obtained from the display panel, where the control signal is used to control the display panel to display image data. The control signal is analyzed to obtain an interference time period at which the touch panel is possibly interfered, so as to generate a trigger signal. A driving voltage and a sensing period of the touch panel are controlled according to the trigger signal, so that the sensing period is not overlapped to the interference time period.

The invention provides a touch detection method for a touch panel. The touch panel is a capacitive touch panel integrated with a display panel. The method is described as follows. When a control circuit determines that the display panel is in a low interference state being determined, a touch panel synchronization signal is provided to the touch panel. A trigger signal is generated according to the touch panel synchronization signal. A driving voltage and a sensing period of the touch panel are controlled according to the trigger signal, so that the sensing period lasts in the low interference state.

The invention provides a touch apparatus including a display panel and a capacitive touch panel. The display panel is controlled by a control circuit to display an image suitable for touching. The capacitive touch panel is disposed on a surface of the display panel, and a touch detection circuit detects a touch position corresponding to the image. The touch detection circuit includes a synchronous resolution control circuit and a driving/sensing circuit. The synchronous resolution control circuit receives at least one control signal used to control the display panel from the control circuit. The control signal carries synchronous information, and is used to control the display panel to display the image. The synchronous information is analyzed by the synchronous resolution control circuit to obtain an interference time period at which the touch panel is possibly interfered, so as to generate a trigger signal. The driving/sensing circuit receives the trigger signal and generates a driving voltage and a sensing period according to the trigger signal to control the touch panel, where the sensing period is not overlapped to the interference time period.

The invention provides a touch apparatus including a display panel and a capacitive touch panel. The display panel displays an image suitable for touching. The capacitive touch panel is disposed on a surface of the display panel, and a touch detection circuit detects a touch position corresponding to the image. The touch detection circuit includes a control circuit, a synchronous resolution control circuit and a driving/sensing circuit. The control circuit generates a trigger signal according to a state of the display panel to trigger the capacitive touch panel to perform a touch detection. The synchronous resolution control circuit receives the trigger signal of the control circuit to analyze trigger time information. The driving/sensing circuit receives the trigger time information to generate a driving voltage and a sensing period to control the capacitive touch panel, where the sensing period is not overlapped to the interference time period.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural schematic diagram of a conventional touch device.

FIG. 2A is a circuit schematic diagram of a conventional touch device.

FIG. 2B is a timing diagram of a driving signal and a scan signal.

FIGS. 3-4 are schematic diagrams of analyzing a noise source of a conventional touch panel according to an embodiment of the invention.

FIGS. 5A-5C are timing schematic diagrams of a touch detection method according to an embodiment of the invention.

FIG. 6 is a functional block schematic diagram of a touch device according to an embodiment of the invention.

FIGS. 7A-7C are timing diagrams of sensing periods adjusted according to a source/gate/VCOM signal according to an embodiment of the invention.

FIGS. 8A-8C are timing diagrams of sensing periods adjusted according to a start pulse signal (STV) and scan clock control signals (CKH) according to an embodiment of the invention.

FIGS. 9A-9C are timing diagrams of sensing periods adjusted according to scan clock control signals (CKH) and a common voltage (VCOM) according to an embodiment of the invention.

FIG. 10 is a schematic diagram illustrating an encoding method of a Vsync signal and an Hsync signal according to an embodiment of the invention.

FIGS. 11A-11B are encoding timing diagrams of signals STV, CKH1, CKH2, CKH3, . . . , CKH6, etc. according to an embodiment of the invention.

FIG. 12 is a timing diagram of a sensing period adjusted by a TPsync signal according to an embodiment of the invention.

FIG. 13 is a schematic diagram of a touch device according to an embodiment of the invention.

FIG. 14 is a structural schematic diagram of a liquid crystal display (LCD) module collocating with a power management circuit according to an embodiment of the invention.

FIG. 15 is a timing diagram of a sensing period of the circuit of FIG. 14 according to an embodiment of the invention.

FIG. 16 is a timing diagram of a sensing period of the circuit of FIG. 14 according to an embodiment of the invention.

FIG. 17 is a timing diagram of a sensing period of the circuit of FIG. 14 according to an embodiment of the invention.

FIG. 18 is a structural schematic diagram of an LCD module collocating with a power management circuit according to an embodiment of the invention.

FIG. 19 is a structural schematic diagram of an LCD module collocating with a power management circuit according to an embodiment of the invention.

FIG. 20 is a structural schematic diagram of an LCD module collocating with a power management circuit according to an embodiment of the invention.

### DETAILED DESCRIPTION OF DISCLOSED EMBODIMENTS

In the invention, by analysing a noise source in a driving and sensing method of a conventional touch panel, a method of reducing interference of a display panel is provided.

Embodiments are provided below for descriptions, though the invention is not limited thereto, and different embodiments can be suitably combined.

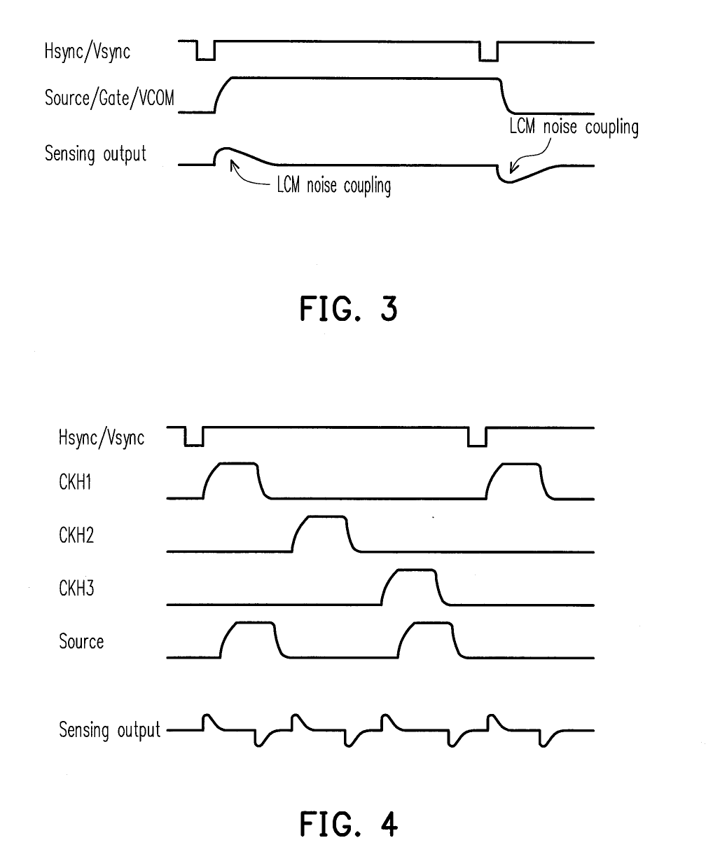

FIGS. 3-4 are schematic diagrams of analyzing a noise source of the conventional touch panel according to an embodiment of the invention.

Referring to FIG. 3, by tracking and analyzing an interference source, it is known that a sensing output noise generally occurs in a voltage transition section of the driving signal. Regarding an A-Si-type liquid crystal display (LCD) panel, after a pulse of a horizontal synchronization signal Hsync or a vertical synchronization signal Vsync is sent, a voltage level of a corresponding source signal, a gate signal or a common voltage signal (VCOM) is transited. Now, the touch panel generates the noise in the signal transition section.

Referring to FIG. 4, regarding a low temperature poly-silicon (LTPS) LCD panel, every three scan clock control signals (CKH) are transmitted in a unit. Similarly, the touch panel generates the noise in the signal transition sections.

Based on the aforementioned discussion and analysis of the interference source, the invention provides a mechanism of reducing a situation that the LCD panel interferes the touch panel.

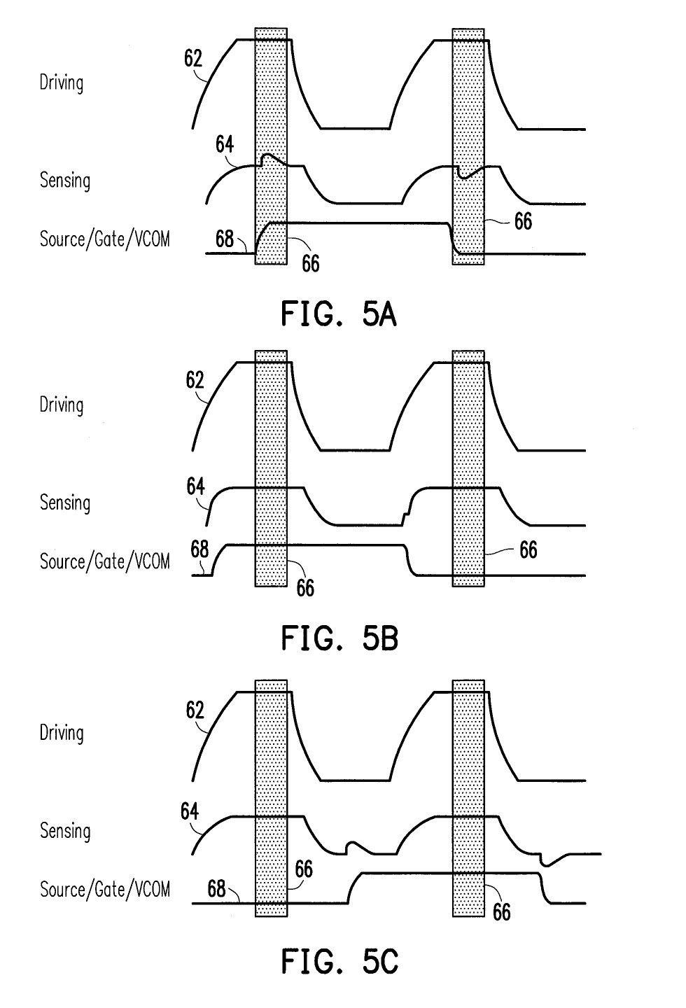

FIGS. 5A-5C are timing schematic diagrams of a touch detection method according to an embodiment of the invention.

Referring to FIG. 5A, taking a source/gate/VCOM signal 68 as a reference, if the touch panel sends a driving signal 62, in a period of time before transition, a sensing signal 64 is generated according to the driving signal 62 to reach a stable state. A sensing period of a dot marking region is generally set at a fixed predetermined time after the driving signal 62 is sent. If the sensing period 66 just falls in the transition section of the source/gate/VCOM signal, the noise is sensed.

Referring to FIG. 5B, if a timing of the driving signal 62 of the touch panel is adjusting according to the transition section of the source/gate/VCOM signal, for example, the timing of the driving signal 62 is adjusted to be consistent with the transition section of the source/gate/VCOM signal 68, the noise is not occurred in the sensing period 66.

Referring to FIG. 5C, generally, a trigger time of the driving signal 62 can be suitably adjusted to avoid overlapping the sensing period 66 to the transition section of the source/gateNCOM signal 68.

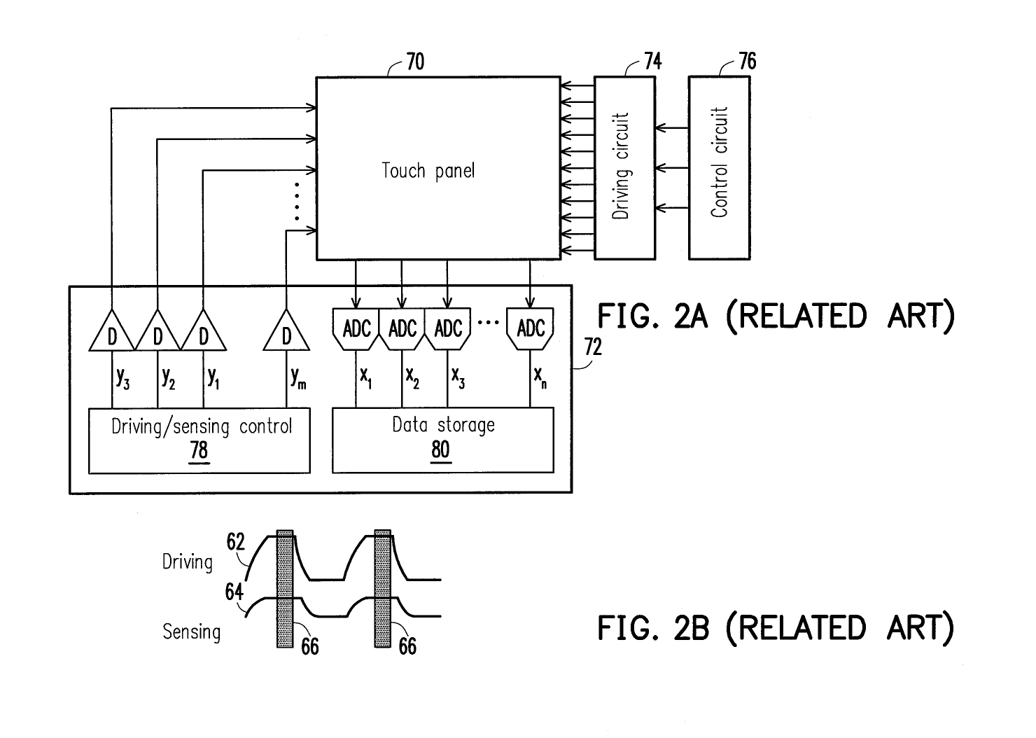

The conventional capacitive touch mechanism of FIG. 2A cannot obtain control signal information of the LCD, so that the sensing period cannot avoid the interference time period of the LCD, which decreases a signal to noise ratio (SNR) of capacitance sensing, and influences accuracy of detected coordinates.

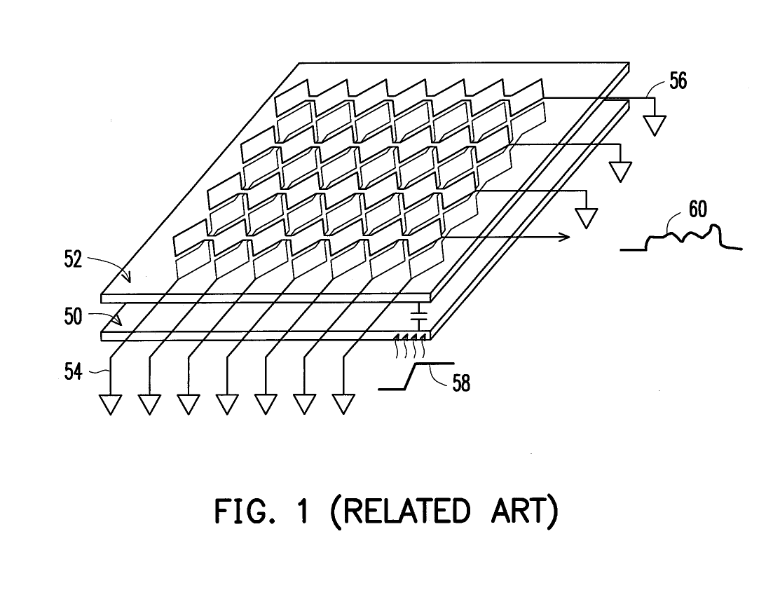

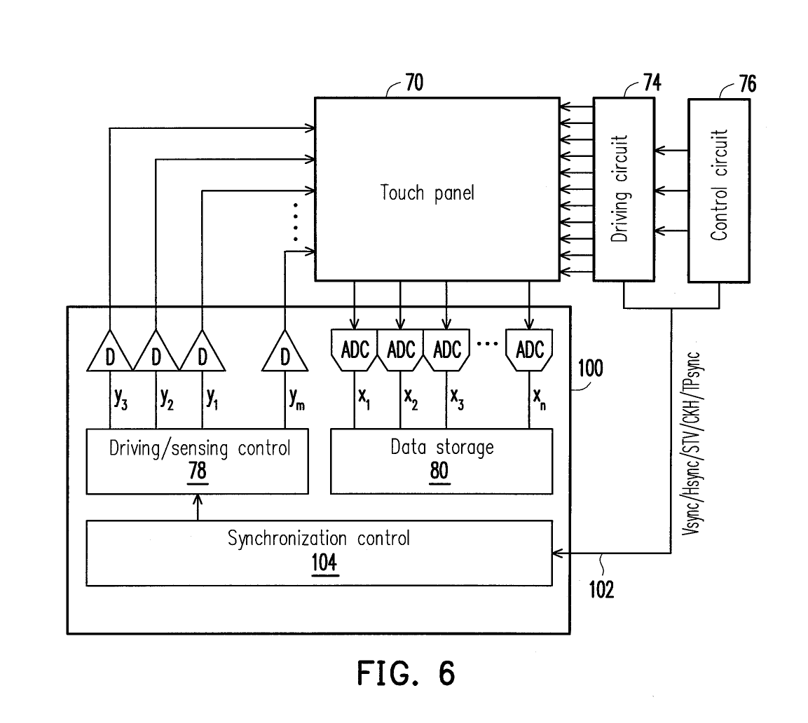

A touch apparatus including a detection circuit structure is provided below. FIG. 6 is a functional block schematic diagram of a touch device according to an embodiment of the invention. Referring to FIG. 6, the touch apparatus has a display panel integrated with a touch panel 70 in a method the same as that of FIG. 1, the display panel is controlled by a control circuit to display an image suitable for touching. The control circuit can be a driving circuit 74 or a control circuit 76 of the LCD system. The display panel is, for example, an LCD panel, and a display mechanism thereof is known by those skilled in the art, which is not repeated.

The capacitive touch panel 70 is disposed on a surface of the display panel, and a touch detection circuit 100 detects a touch position corresponding to the image displayed by the display panel to operate the touch function.

The touch detection circuit 100 includes a synchronous resolution control circuit 104, a driving/sensing circuit 78 and a data storage unit 80.

The synchronous resolution control circuit 104 receives at least one control signal 102 from the driving circuit 74 or the control circuit 76. The control signal 102 carries direct or indirect synchronous information, which is used to control the display panel to display the image. The control signal 102 is, for example, at least one of a horizontal synchronization signal Hsync, a vertical synchronization signal Vsync, a start pulse signal STV, a scan clock control signal CKH, and a touch panel synchronization signal TPsync. Moreover, the control signal 102 can also be the aforementioned common voltage signal, source control signal or gate control signal.

In other words, the control signal is analyzed by the synchronous resolution control circuit 104 to obtain an interference time period at which the touch panel is possibly interfered, so as to generate a trigger signal. The driving/sensing circuit 78 receives the trigger signal and generates the driving voltage according to the trigger signal, and controls scanning of the touch panel 70 in collaboration with the delayed sensing period of the driving voltage.

It should be noticed that the sensing period is not overlapped to the interference time period, by which the interference is reduced.

In the sensing period, an analog value of scan sensing is converted into digital information by an analog-to-digital converter (ADC). The digital information can be stored in the data storage unit 80 for subsequent touch analysis.

A method of obtaining the control signal 102 is to configure a communication interface to introduce the control signal 102, though the invention is not limited to a specific layout, and according to the diving circuits of the display panels of different types, different signal contents are obtained according to the considered interference sources. The basic interference source is, for example, source driver interference, gate driver interference, or common voltage interference, etc. Therefore, the driving circuit of the display panel transmits “not-coded” or “encoded” signal variation information to the touch detection circuit while displaying an image, so as to provide related information of the display panel to the touch detection circuit 100 of the touch panel.

The synchronous resolution control circuit 104 of the touch detection circuit 100 can analyze the interference-related information transmitted from the gate and source driving circuit 74 or the control circuit 76 of the LCD system into a trigger signal synchronous to the touch detection circuit 100. The trigger signal is provided to the driving/sensing circuit 78 for utilization.

After the driving/sensing circuit 78 receives the trigger signal, based on a variation time period of the trigger signal, the sensing period can be delayed or not by a certain time period to activate the sensing capacitor circuit.

Sensing timing relationships corresponding to a plurality of interference sources are described below.

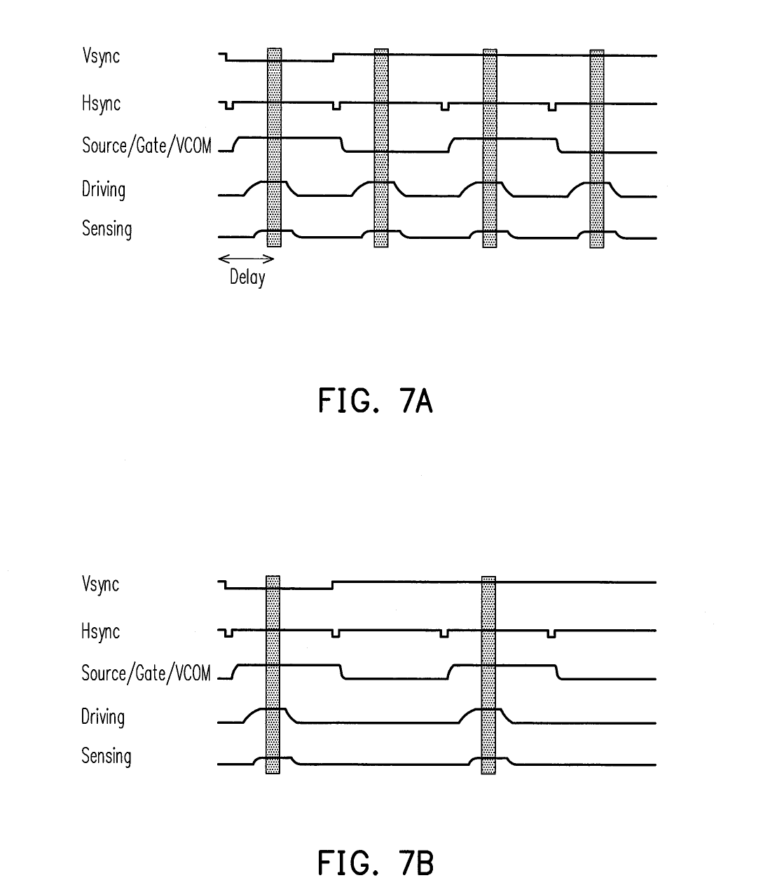

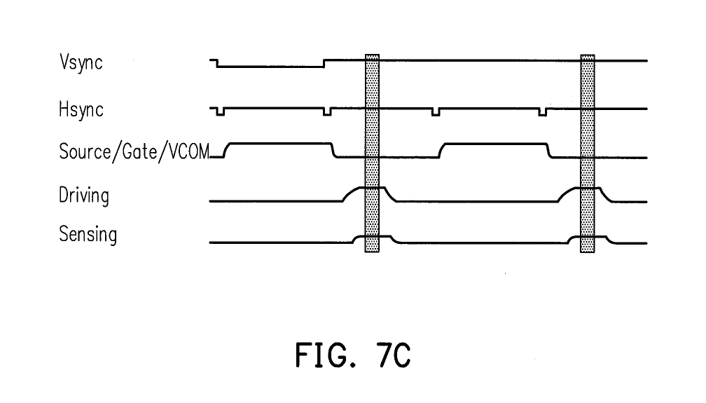

FIGS. 7A-7C are timing diagrams of sensing periods adjusted according to a source/gate/VCOM signal according to an embodiment of the invention.

Referring to FIG. 7A, the not-coded signal sources of the display panel has a vertical synchronization signal and a horizontal synchronization signal. The vertical synchronization signal is generally referred to as a Vsync signal, and the horizontal synchronization signal is generally referred to as an Hsync signal. The Vsync signal can provide a first display time, which is used to synchronize a frame. Moreover, variation of the source/gate/VCOM signal can be constructed according to the Hsync signal. According to the method of the invention, a signal source variation point is taken as the trigger signal, for example, the sensing period of a dot marking region can be delayed by a certain time period relative to the Hsync signal to activate the sensing capacitor circuit for sensing, so as to avoid a voltage transition section. However, if an activating time of the source/gate/VCOM signal is delayed relative to the Hsync signal, the sensing period may not be delayed. The only thing to be considered is to avoid overlapping the sensing period to the voltage transition section of the source/gate/VCOM signal.

Referring to FIG. 7B, according to the same consideration, another method of avoiding the interference is to trigger the sensing period only in a high level section of the VCOM signal. In this way, a start or end section of signal variation is avoided.

Referring to FIG. 7C, similar to FIG. 7B, another method of avoiding the interference is to trigger the sensing period only in a low level section of the VCOM signal. In this way, the start or end section of signal variation is avoided.

The not-coded signal sources include the Vsync signal and the Hsync signal. However, it is unnecessary to require existence of both of the Vsync signal and the Hsync signal for synchronization, and each has its own usage.

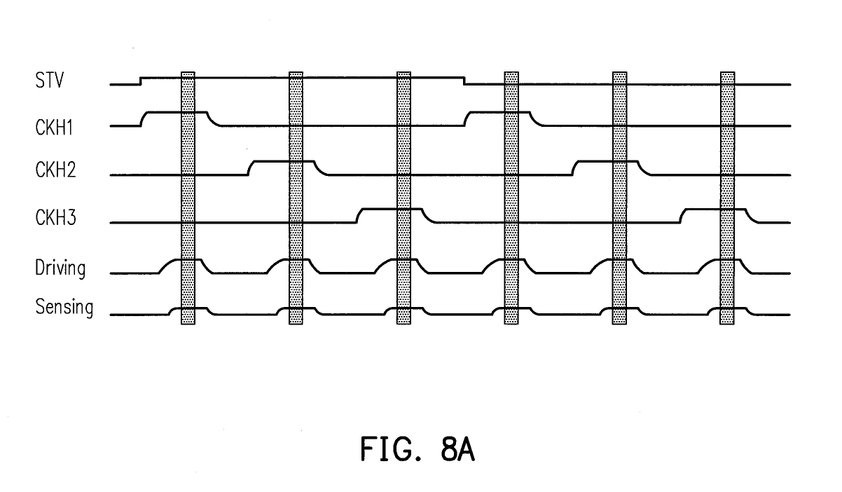

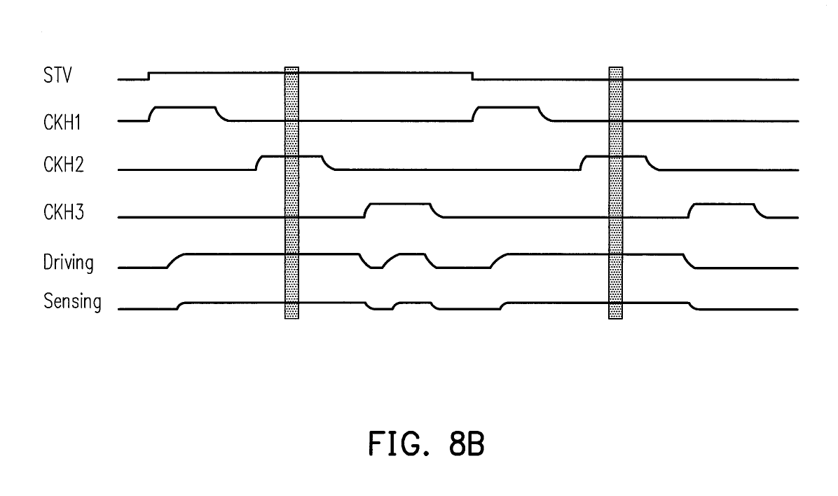

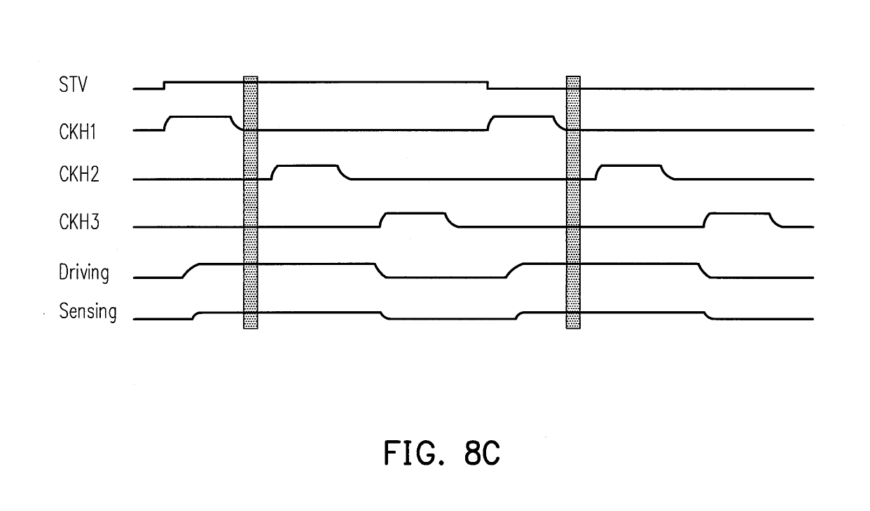

FIGS. 8A-8C are timing diagrams of sensing periods adjusted according to a start pulse signal (STV) and scan clock control signals (CKH) according to an embodiment of the invention.

Referring to FIG. 8A, the sensing period of the touch panel can also be adjusted according to the timing of the start pulse signal and the scan clock control signals. The start pulse signal is generally referred to as a STV signal. The scan clock control signal is generally referred to as a CKH signal, where a plurality of CHK signals forms one set, which is generated in collaboration with the SATV signal. In the present embodiment, a 1-to-3 de-multiplexing method is taken as an example for descriptions, so that three CKH signals CKH1, CKH2 and CKH3 are taken as an example for descriptions. According to the same principle, the sensing period of the touch panel, for example, the dot marking region is required to avoid overlapping the voltage transition sections of the control signals.

The not-coded signals STV and CKH, etc can provide the first display time, which is used to synchronize a frame. According to the method of the invention, the signal source variation point is taken as the trigger signal to delay or not to delay a certain time period to activate the sensing capacitor circuit.

Referring to FIG. 8B, the sensing capacitor circuit can be activated when any of the CKH signals CKH1, CKH2 and CKH3 has a high level. In the present embodiment, the sensing capacitor circuit is activated when the CKH signal CKH2 has the high level.

Referring to FIG. 8C, the sensing capacitor circuit can be activated when all of the CKH signals CKH1, CKH2 and CKH3 have a low level.

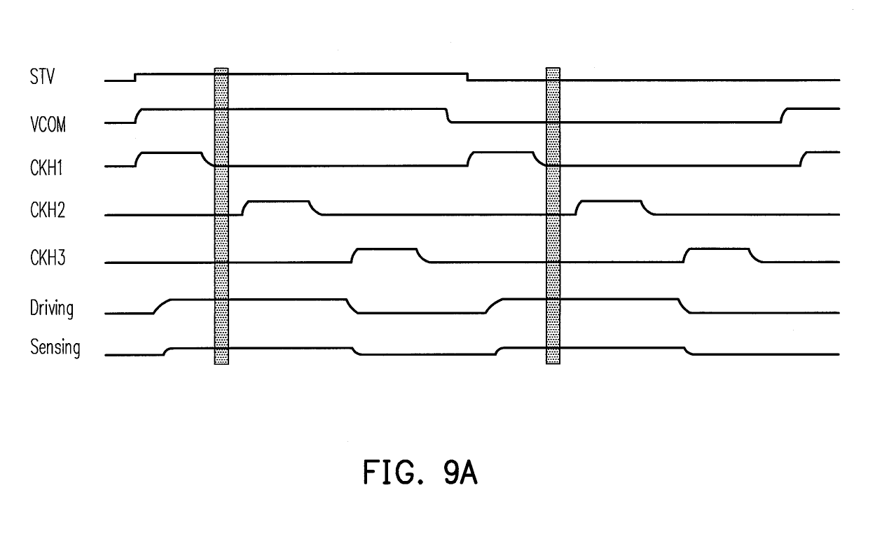

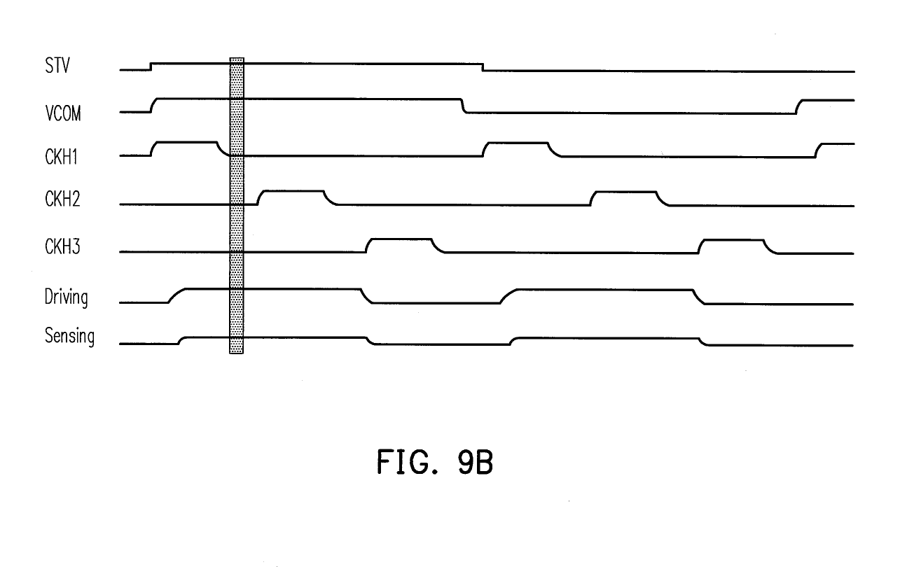

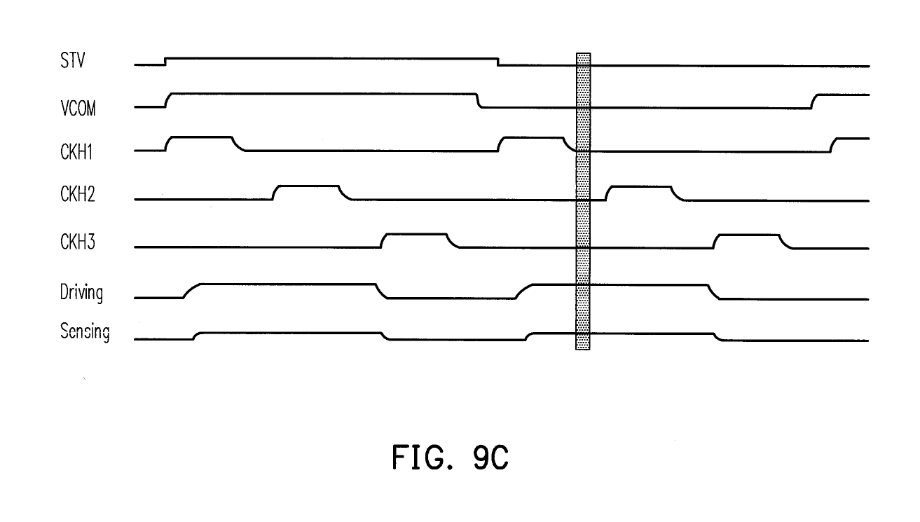

FIGS. 9A-9C are timing diagrams of sensing periods adjusted according to scan clock control signals (CKH) and a common voltage (VCOM) according to an embodiment of the invention.

Referring to FIG. 9A, after the set of CKH signals CKH1, CKH2 and CKH3, the VCOM signal is transited, so that activation of the sensing period can be delayed by a certain time period to activate the sensing capacitor circuit. However, the timing of the other signals may not be delayed, and a consideration principle is to avoid overlapping the transition section.

Referring to FIG. 9B, the sensing capacitor circuit can be activated when the VCOM signal has a high level.

Referring to FIG. 9C, the sensing capacitor circuit can be activated when the VCOM signal has a low level.

It should be noticed that it is unnecessary to require existence of both of the not-coded signal sources (the STV signal and the CKH signal) for synchronization, and each has its own usage. Regarding the CKH signal, the invention is not limited to use the 1-to-3 de-multiplexing, and other types can also be used.

Further, regarding the Vsync signal and the Hsync signal of the signal sources, it generally requires two transmission lines to transmit the signals to the touch detection circuit 100. However, the two signals can also be encoded as a new signal, so that only one transmission line is required. The encoded signal is referred to as a touch panel synchronization signal, which can be referred to as a TPsync signal. The TPsync signal can be encoded through the driving circuit 74 or the control circuit 76.

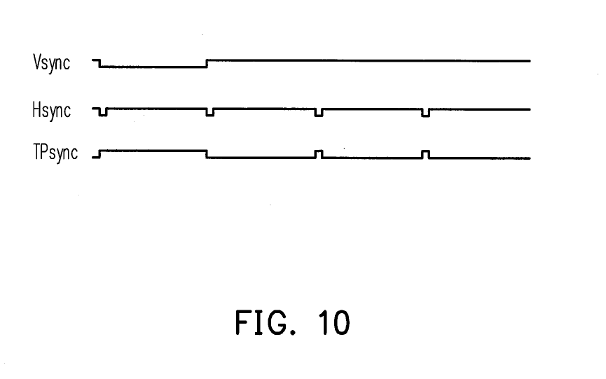

FIG. 10 is a schematic diagram illustrating an encoding method of the Vsync signal and the Hsync signal according to an embodiment of the invention. Referring to FIG. 10, the TPsync signal is obtained by encoding the Vsync signal and the Hsync signal. Since a timing relationship of the Vsync signal and the Hsync signal only has the low level at a first Hsync signal period, when a time for the TPsync signal being in the high level is greater than or equal to a reference time, it can be regarded as an actuation time of the Vsync signal. When a time for the TPsync signal being in the high level is smaller than the reference time, it can be regarded as an actuation time of the Hsync signal. One TPsync signal not only has first Vsync signal display information, but also has timing variation of each scan line for reference.

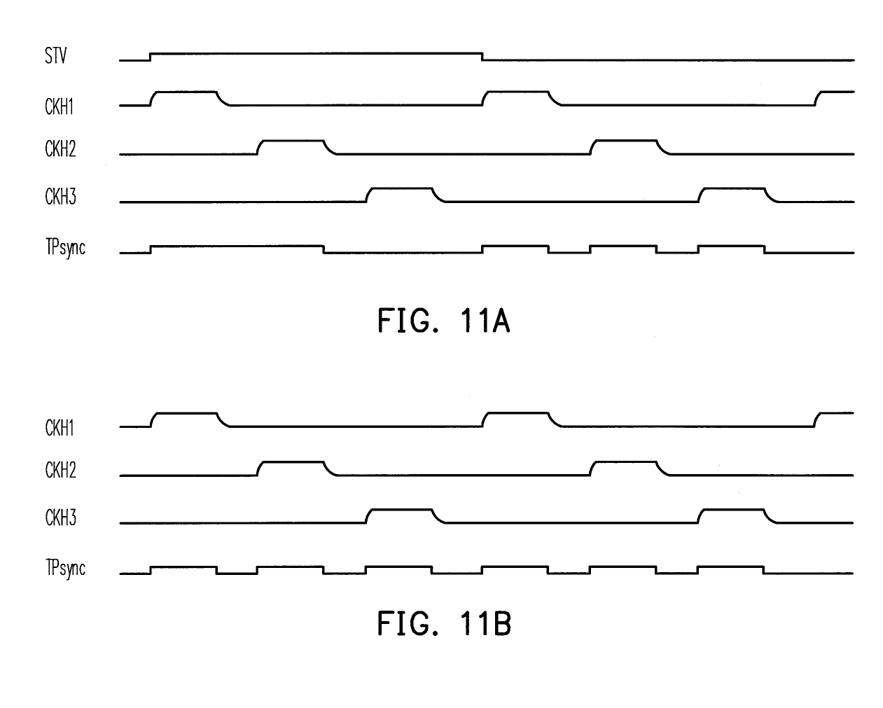

FIGS. 11A-11B are encoding timing diagrams of signals STV, CKH1, CKH2, CKH3, . . . , CKH6, etc. according to an embodiment of the invention.

Referring to FIG. 11A, the signal sources come from the display panel are, for example, the signals STV, CKH1, CKH2, CKH3, . . . , CKH6, etc., and four to seven transmission lines are required to transmit the signals to the touch detection circuit 100 according to the number of the CKH signals. The TPsync signal is obtained by encoding the STV signal and the CKH signal. When a time for the TPsync signal being in the high level is greater than or equal to a reference time, it can be regarded as an actuation time of the STV signal. When a time for the TPsync signal being in the high level is smaller than the reference time, it can be regarded as an actuation time of the CKH signal. In this way, one TPsync signal has timing variation of the STV signal and each of the CKH signals.

Referring to FIG. 11B, the TPsync signal can also be obtained by encoding the CKH signals.

Further, the output enable pulse of the gate driver of the display panel can also be used as the TPsync signal.

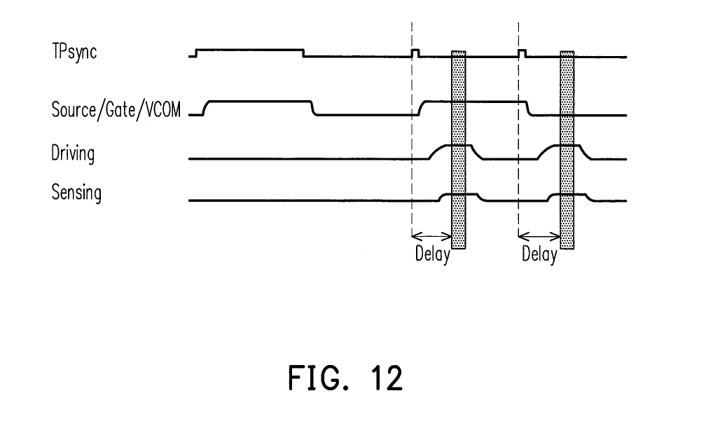

FIG. 12 is a timing diagram of the sensing period adjusted by the TPsync signal according to an embodiment of the invention.

Referring to FIG. 12, after the touch detection circuit 100 receives the encoded TPsync signal, it decodes the encoded TPsync signal into the signals Vsync and Hsync or the signals STV and CKH, etc., and performs the touch detection scan. The sensing period is, for example, the dot marking region, which avoids the voltage transition sections.

Moreover, the TPsync signal of the invention can be purely a trigger signal, which controls a scan timing of the touch detection circuit 100 through and the control circuit 76 of the LCD system or a general control circuit.

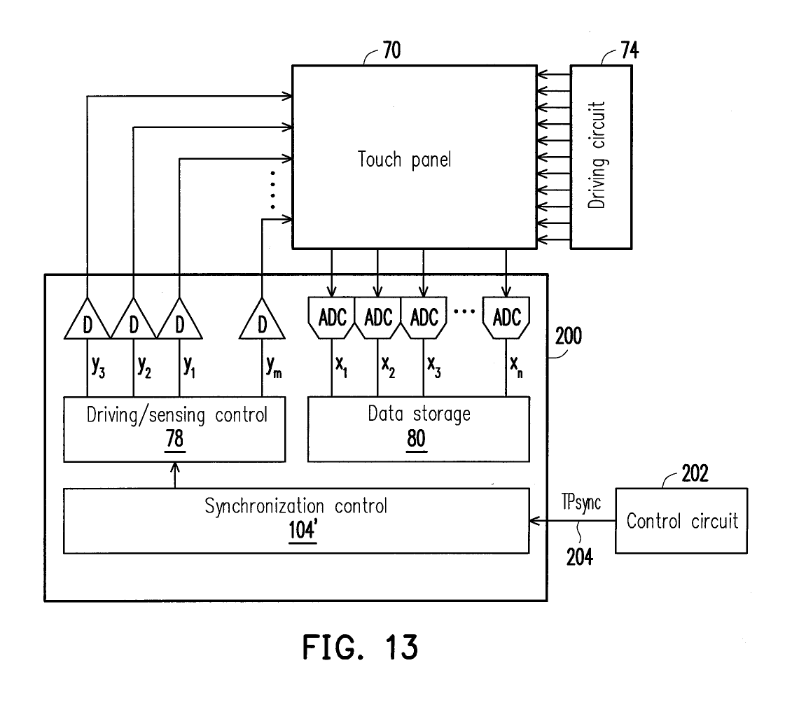

FIG. 13 is a schematic diagram of a touch device according to an embodiment of the invention. Referring to FIG.13, the touch device of the present embodiment is similar to the touch device of FIG. 6, though a triggering mechanism of the touch detection circuit 200 is different. The touch detection circuit 200 includes a synchronous resolution control circuit 104′, a driving/sensing circuit 78′ and a data storage unit 80. The touch detection circuit 200 is controlled by a trigger signal generated by a control circuit 202. The control circuit 202 can be the control circuit 76 of the display panel or a control circuit outside the display panel, which is used to generate the trigger signal, and the synchronous resolution control circuit 104′ analyzes a timing of the trigger signal to control the driving/sensing circuit 78′ to drive and sense.

In other words, the TPsync signal output by the control circuit 202 is directly the trigger signal. The control circuit 202 can directly generate the trigger signal by analysing a state of the display panel. The state of the display panel is, for example, a state tending to a static display, so that the interference generated due to frequent changing of images of the display panel is relatively less.

Further, an LCD module is generally used in collocation with a power integrated circuit (IC), and when the power IC is controlled by an LCD controller, since a power clock of the power IC is generally related to an LCD display timing, the aforementioned control circuit 202 can also be integrated in the power IC to serve as a basis of synchronization according to the related timing of the power clock.

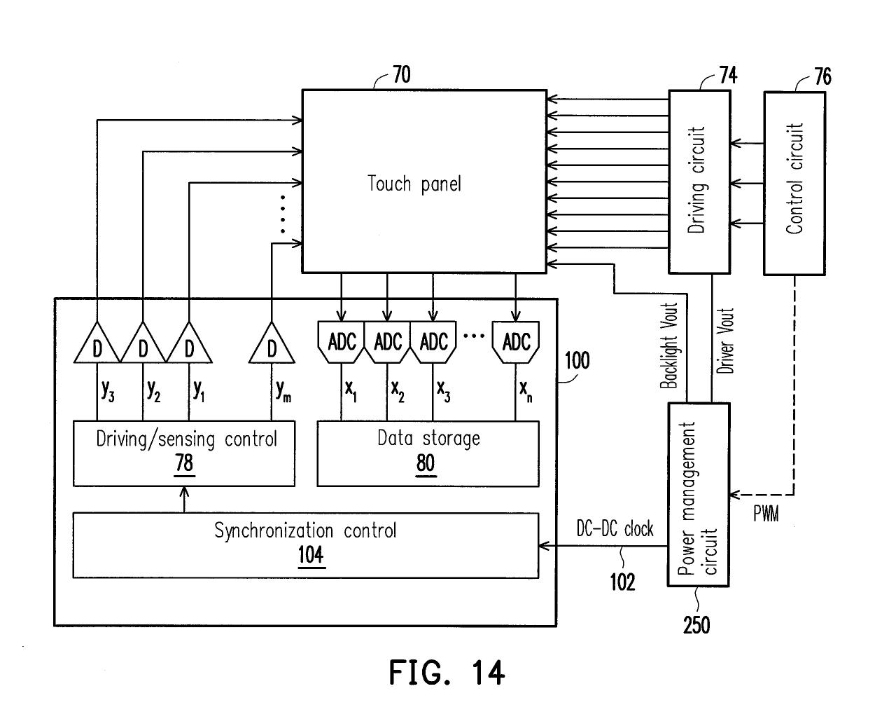

FIG. 14 is a structural schematic diagram of an LCD module collocating with a power management circuit according to an embodiment of the invention.

Referring to FIG. 14, in another structure, the LCD module is also used in collocation with an IC of the power management circuit 250. The power management circuit 250 can output power required by a driving voltage signal used to control the driving circuit 74 and a backlight driving signal used for controlling a backlight of the touch panel 70. An operation process of the power management circuit 250 on a system board may possibly generate power noise to influence a main power on the system board, and since the touch detection circuit 100 uses the same main power on the system board, the touch detection circuit 100 is also influenced by the power noise generated by the power management circuit 250.

In the power management circuit 250, in an operation process of a direct current (DC)-DC conversion circuit, the power noise is generated to the main power VDD or the ground power GND according to a DC-DC clock. Such noise may also influence the touch sensing. According to a method provided by an embodiment of the invention, the DC-DC clock is taken as the control signal 102, which servers as the trigger signal with reference of a DC-DC clock variation point, and is delayed by a certain time period to activate the sensing capacitor circuit, so as to avoid the noise interference.

In an embodiment, one set of communication interface is used to transmit signal variation information of the power management circuit 250 to the touch detection circuit 100. The control circuit 76 can control the power management circuit 250 through a pulse width modulation (PWM) control terminal. The driving/sensing control unit 78 analyzes a synchronization signal received by the synchronous resolution control circuit 104 by using the signal received from the power management circuit 250, so that the touch detection circuit 100 can avoid an interference time.

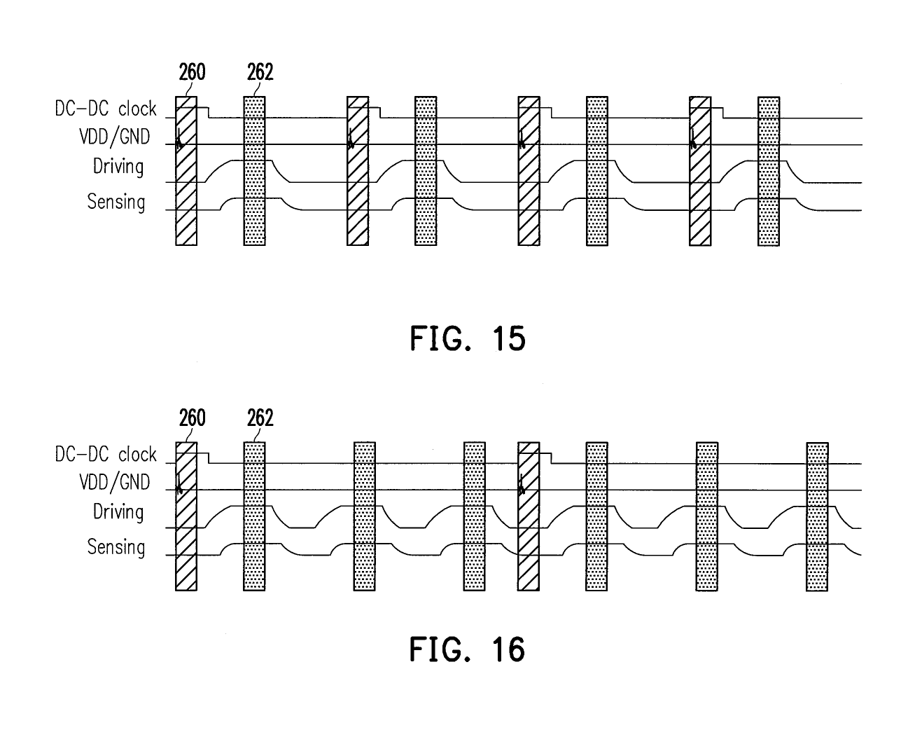

FIG. 15 is a timing diagram of a sensing period of the circuit of FIG. 14 according to an embodiment of the invention. Referring to FIG. 15, regarding the power management circuit 250 and the driving/sensing control unit 78, if a frequency of the DC-DC clock is close to a scan frequency, each variation point 260 of the DC-DC clock can trigger one capacitor scan section 262.

FIG. 16 is a timing diagram of a sensing period of the circuit of FIG. 14 according to an embodiment of the invention. Referring to FIG. 16, regarding the power management circuit 250 and the driving/sensing control unit 78, if the frequency of the DC-DC clock is slower and the scan frequency is faster, a plurality of the capacitor scan sections 262 can be triggered between two variation points 260 of the DC-DC clock.

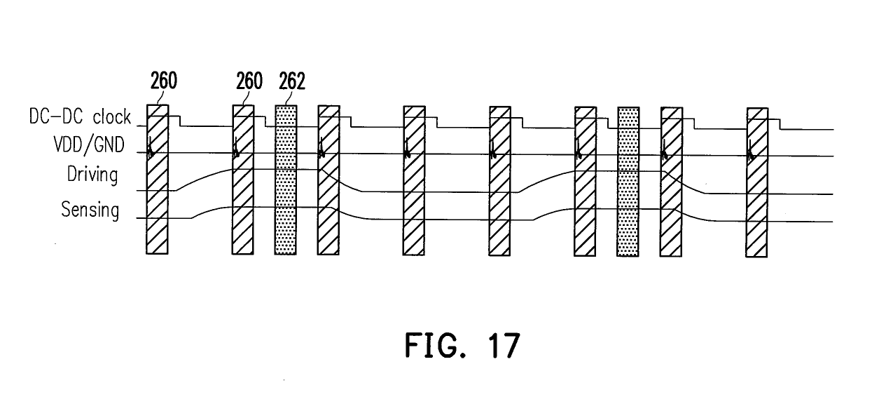

FIG. 17 is a timing diagram of a sensing period of the circuit of FIG. 14 according to an embodiment of the invention. Referring to FIG. 17, regarding the power management circuit 250 and the driving/sensing control unit 78, if the frequency of the DC-DC clock is faster and the scan frequency is slower, one capacitor scan section 262 is triggered according to one of the variation points 260 of the DC-DC clock. Although the capacitor scan section is interfered by the noise for several times, the number of times of the interference is fixed, so that it has fixed noise interference.

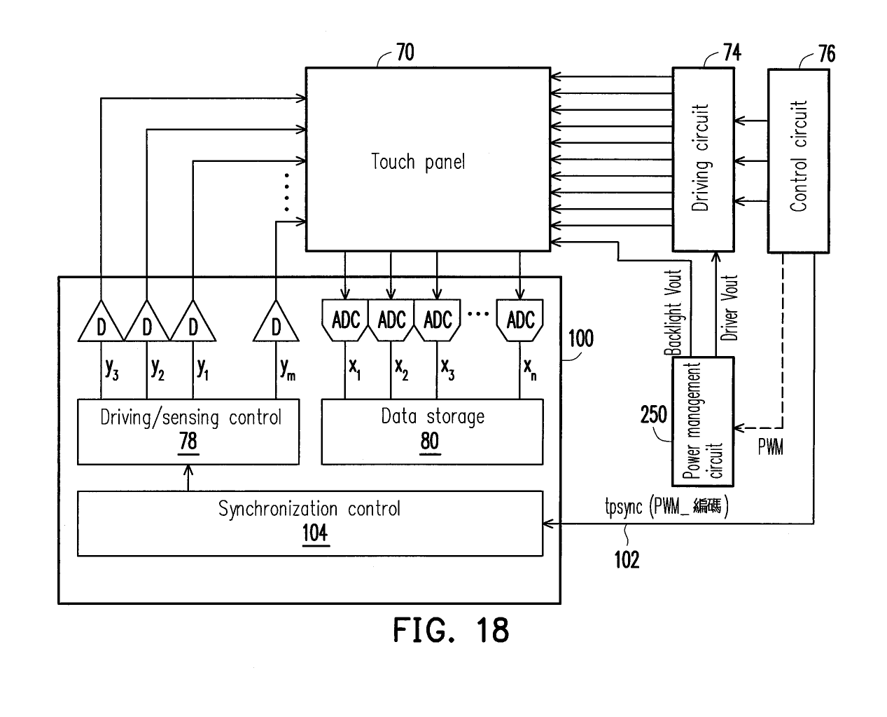

FIG. 18 is a structural schematic diagram of an LCD module collocating with a power management circuit according to an embodiment of the invention.

Referring to FIG. 18, one set of communication interface is used to transmit signal variation information of the power management circuit 250 to the touch detection circuit 100. The control circuit 76 can control the power management circuit 250 through the PWM control terminal, and the TPsync signal is generated according to the PWM signal to serve as the control signal 102, so as to control the touch detection circuit 100 to avoid the interference time.

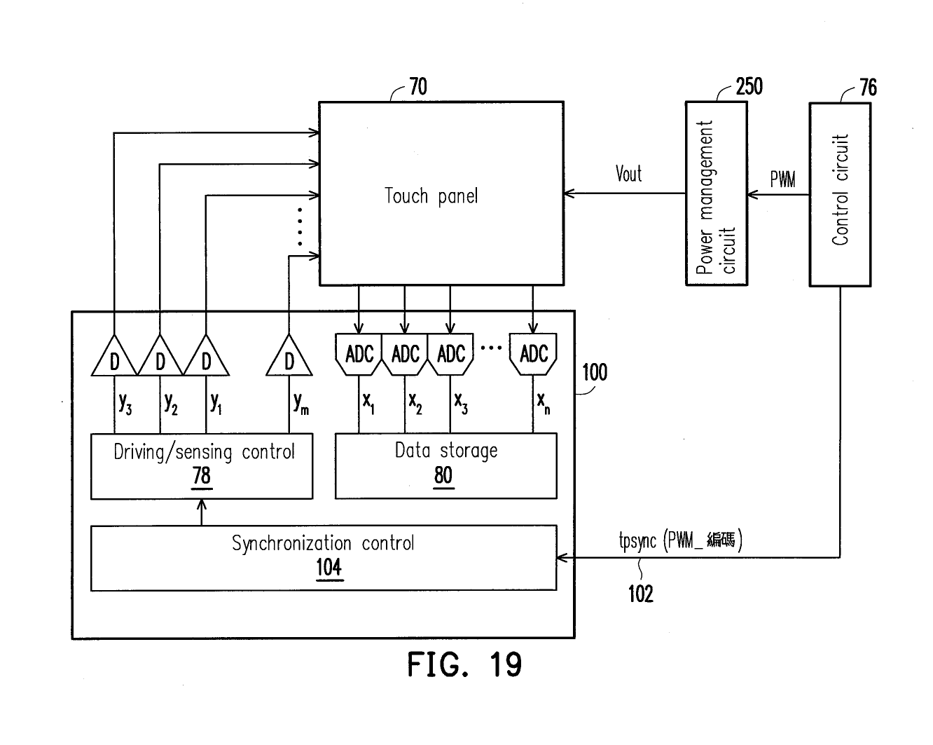

FIG. 19 is a structural schematic diagram of an LCD module collocating with a power management circuit according to an embodiment of the invention.

Referring to FIG. 19, one set of communication interface is used to transmit variation information of the PWM signal to the touch detection circuit 100. The control circuit 76 can control the power management circuit 250 through the PWM control terminal, and the TPsync signal is generated according to the PWM signal to serve as the control signal 102, so as to control the touch detection circuit 100 to avoid the interference time.

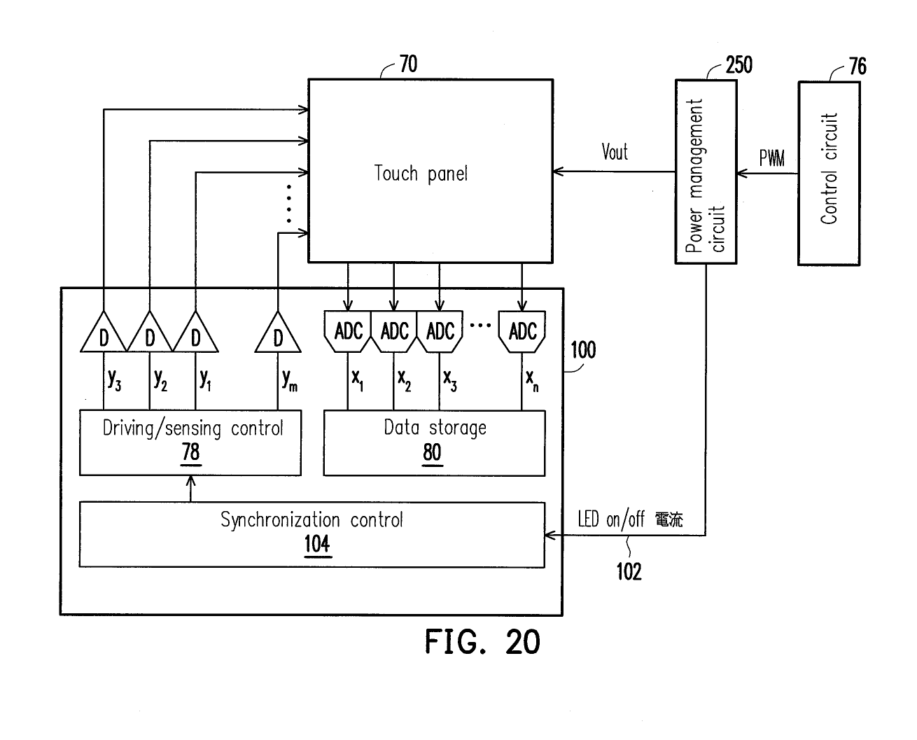

FIG. 20 is a structural schematic diagram of an LCD module collocating with a power management circuit according to an embodiment of the invention.

Referring to FIG. 20, one set of communication interface is used to transmit signal variation information of the power management circuit 250 to the touch detection circuit 100. A light-emitting diode (LED) on/off signal used to control an LED current that is output form the power management circuit 250 is taken as the control signal 102 to control the touch detection circuit 100 to avoid the interference time. The LED current is generally a current signal used for turning on/off a backlight source.

The touch detection circuit of the invention determines the sensing period with reference o the synchronous control signal of the display panel. The sensing period is not overlapped to the interference time period, so that accuracy of touch sensing is improved.

The touch detection circuit of the invention directly provide the trigger signal through the control circuit according to a display state of the display panel, so as to trigger the touch panel to perform the touch detection.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch detection method for a touch panel, wherein the touch panel is a capacitive touch panel integrated with a display panel, the touch detection method comprising:
obtaining at least one control signal carrying synchronous information from the display panel, wherein the control signal is used to control the display panel to display image data;
analysing the control signal to obtain an interference time period at which the touch panel is possibly interfered, so as to generate a trigger signal; and
controlling a driving voltage and a sensing period of the touch panel according to the trigger signal, so that the sensing period is not overlapped to the interference time period.

2. The touch detection method as claimed in claim 1, wherein the at least one control signal is a vertical synchronization signal, a horizontal synchronization signal, a start pulse signal, a scan clock control signal, a common voltage signal, a source control signal, a gate control signal or a touch panel synchronization signal.

3. The touch detection method as claimed in claim 1, wherein the sensing period is delayed by a certain time relative to the trigger signal.

4. The touch detection method as claimed in claim 1, wherein the sensing period is not in a voltage transition section of the at least one control signal.

5. The touch detection method as claimed in claim 1, wherein the at least one control signal comprises a vertical synchronization signal and a horizontal synchronization signal to construct a common voltage signal, a source control signal and a gate control signal, wherein the sensing period is not in a voltage transition section of at least one of the common voltage signal, the source control signal and the gate control signal.

6. The touch detection method as claimed in claim 1, wherein the at least one control signal comprises a start pulse signal and a plurality of scan clock control signals, wherein the sensing period is not in voltage transition sections of the start pulse signal and the scan clock control signals.

7. The touch detection method as claimed in claim 1, wherein the at least one control signal comprises an encoded signal obtained by encoding a plurality of control signals, wherein the sensing period is not in voltage transition sections of the control signals.

8. The touch detection method as claimed in claim 1, wherein the at least one control signal comprises a touch panel synchronization signal, wherein the sensing period is not in a voltage transition section of the touch panel synchronization signal.

9. The touch detection method as claimed in claim 1, wherein the at least one control signal comprises a touch panel synchronization signal, and the touch panel synchronization signal is an output enable pulse of a gate driver, wherein the sensing period is not in a voltage transition section of the touch panel synchronization signal.

10. The touch detection method as claimed in claim 1, wherein the at least one control signal comprises information of a pulse width modulation signal.

11. The touch detection method as claimed in claim 1, wherein the at least one control signal comprises power management information of a power management circuit.

12. A touch detection method for a touch panel, wherein the touch panel is a capacitive touch panel integrated with a display panel, the touch detection method comprising:
providing a touch panel synchronization signal to the touch panel when a control circuit determines that the display panel is in a low interference state being determined;
generating a trigger signal according to the touch panel synchronization signal; and
controlling a driving voltage and a sensing period of the touch panel according to the trigger signal, so that the sensing period lasts in the low interference state.

13. The touch detection method as claimed in claim 12, wherein the control circuit is a part of a control circuit of the display panel or a circuit outside the display panel.

14. The touch detection method as claimed in claim 12, wherein the touch panel synchronization signal comprises information of a pulse width modulation signal.

15. The touch detection method as claimed in claim 12, wherein the touch panel synchronization signal comprises power management information of a power management circuit.

16. A touch apparatus, comprising:
a display panel, controlled by a control circuit to display an image suitable for touching; and
a capacitive touch panel, disposed on a surface of the display panel, and a touch detection circuit detecting a touch position corresponding to the image, wherein the touch detection circuit comprises:
a synchronous resolution control circuit, receiving at least one control signal used to control the display panel from the control circuit, wherein the control signal carries synchronous information, and is used to control the display panel to display the image, wherein the synchronous information is analyzed by the synchronous resolution control circuit to obtain an interference time period at which the touch panel is possibly interfered, so as to generate a trigger signal; and
a driving/sensing circuit, receiving the trigger signal and generating a driving voltage and a sensing period according to the trigger signal to control the touch panel, wherein the sensing period is not overlapped to the interference time period.

17. The touch apparatus as claimed in claim 16, wherein the display panel is a liquid crystal display panel.

18. The touch apparatus as claimed in claim 16, wherein the at least one control signal is a vertical synchronization signal, a horizontal synchronization signal, a start pulse signal, a scan clock control signal, a common voltage signal, a source control signal, a gate control signal or a touch panel synchronization signal.

19. The touch apparatus as claimed in claim 16, wherein the sensing period is delayed by a certain time relative to the trigger signal.

20. The touch apparatus as claimed in claim 16, wherein the sensing period is not in a voltage transition section of the at least one control signal.

21. The touch apparatus as claimed in claim 16, wherein the at least one control signal comprises a vertical synchronization signal and a horizontal synchronization signal to construct a common voltage signal, a source control signal and a gate control signal, wherein the sensing period is not in a voltage transition section of at least one of the common voltage signal, the source control signal and the gate control signal.

22. The touch apparatus as claimed in claim 16, wherein the at least one control signal comprises a start pulse signal and a plurality of scan clock control signals, wherein the sensing period is not in voltage transition sections of the start pulse signal and the scan clock control signals.

23. The touch apparatus as claimed in claim 16, wherein the at least one control signal comprises an encoded signal obtained by encoding a plurality of control signals, wherein the sensing period is not in voltage transition sections of the control signals.

24. The touch apparatus as claimed in claim 16, wherein the at least one control signal comprises a touch panel synchronization signal, wherein the sensing period is not in a voltage transition section of the touch panel synchronization signal.

25. The touch apparatus as claimed in claim 16, wherein the at least one control signal comprises a touch panel synchronization signal, and the touch panel synchronization signal is an output enable pulse of a gate driver, wherein the sensing period is not in a voltage transition section of the touch panel synchronization signal.

26. The touch apparatus as claimed in claim 16, wherein the control circuit comprises at least one of a display panel driver and a display panel controller.

27. The touch apparatus as claimed in claim 16, wherein the control circuit provides information of a pulse width modulation signal.

28. The touch apparatus as claimed in claim 16, wherein the control circuit provides power management information of a power management circuit.

29. A touch apparatus, comprising:
a display panel, displaying an image suitable for touching;
a capacitive touch panel, disposed on a surface of the display panel, and a touch detection circuit detecting a touch position corresponding to the image, wherein the touch detection circuit comprises:
a control circuit, generating a trigger signal according to a state of the display panel to trigger the capacitive touch panel to perform a touch detection;
a synchronous resolution control circuit, receiving the trigger signal of the control circuit to analyze trigger time information; and
a driving/sensing circuit, receiving the trigger time information to generate a driving voltage and a sensing period to control the capacitive touch panel, wherein the sensing period is not overlapped to the interference time period.

30. The touch apparatus as claimed in claim 29, wherein the control circuit is a control circuit of the display panel or a circuit outside the display panel.

31. The touch apparatus as claimed in claim 29, wherein the control circuit provides information of a pulse width modulation signal.

32. The touch apparatus as claimed in claim 29, wherein the control circuit provides power management information of a power management circuit.
